(19) United States
(12) Patent Application Publication
(10) Pub. No.: US 2016/0006029 A1
(43) Pub. Date: Jan. 7, 2016

(54) NON-AQUEOUS ELECTROLYTE SECONDARY BATTERY POSITIVE ELECTRODE ACTIVE MATERIAL AND NON-AQUEOUS ELECTROLYTE SECONDARY BATTERY BY USING SAME

(71) Applicant: SANYO ELECTRIC CO., LTD., Daito-shi, Osaka (JP)

(72) Inventors: Junichi Sugaya, Osaka (JP); Manabu Takijiri, Hyogo (JP); Takeshi Ogasawara, Hyogo (JP); Katsunori Yanagida, Hyogo (JP)

(73) Assignee: SANYO ELECTRIC CO., LTD., Daito-shi, Osaka (JP)

(21) Appl. No.: 14/763,417

(22) PCT Filed: Mar. 18, 2014
(86) PCT No.: PCT/JP2014/001537

§ 371 Date: Jul. 24, 2015

(30) Foreign Application Priority Data
Mar. 26, 2013 (JP) 2013-063397

(51) Int. Cl. H01M 4/485; H01M 4/36; H01M 4/50; H01M 4/505; H01M 4/52

(52) U.S. Cl. CPC H01M 4/485; H01M 4/505; H01M 4/523; H01M 4/502; H01M 4/366; H01M 10/0525

(57) ABSTRACT

A high-capacity non-aqueous electrolyte secondary battery capable of maintaining good cycle characteristics even in the case where large current discharge is repeated is provided. A positive electrode active material particle (32) includes a base particle (33) produced by agglomeration of primary particles (33a) made from lithium transition metal oxide containing tungsten and a rare earth compound particles (34) attached to the surface of the base particle (33). Preferably, the rare earth compound is attached to the interface at which the primary particles are in contact with each other or the vicinity of the interface.

### TECHNICAL FIELD

The present invention relates to a non-aqueous electrolyte secondary battery positive electrode active material and a non-aqueous electrolyte secondary battery by using the same.

### BACKGROUND ART

A lithium ion secondary battery, which is a typical non-aqueous electrolyte secondary battery, has a high energy density and, therefore, has been widely utilized as a driving power supply for mobile information terminals, e.g., cellular phones and notebook personal computers. Also, non-aqueous electrolyte secondary batteries, e.g., the lithium ion secondary battery, have been noted as power supplies for the power of electric tools, electric cars, and the like and the range of uses is expected to further increase.

In consideration of such circumstances, further improvement of cycle characteristics and the like have been required. For example, Patent Document 1 discloses a non-aqueous electrolyte secondary battery in which the resistance at an interface between a positive electrode active material and an electrolytic solution is reduced by adding tungsten (W) and the like in firing of the positive electrode active material in order to improve the output characteristics and cycle characteristics. Also, Patent Document 2 discloses a non-aqueous electrolyte secondary battery in which an oxide of gadolinium (Gd) or the like is allowed to present on the surface of the base particle capable of occluding and releasing lithium ions.

### CITATION LIST

### Patent Document

Patent Document 1: Japanese Published Unexamined Patent Application No. 2009-289726

Patent Document 2: International Publication No. 2005/008812

### SUMMARY OF INVENTION

### Technical Problem

Meanwhile, in recent years, the non-aqueous electrolyte secondary battery has been required to maintain good cycle characteristics even in the case where large current discharge is repeated and, in addition, achieve higher capacity. In particular, these requirements are considerable in the uses of electric tools, electric cars, and the like.

However, the technologies in the related art including technologies disclosed in the above-described patent documents, cracking, which occurs easily in large current discharge, of a positive electrode active material particle cannot be suppressed sufficiently. In an initial stage of charging, a protective coating film (SEI coating film) is formed on the surface of the positive electrode active material particle and a side reaction between the active material and the electrolytic solution is suppressed. However, if cracking of the particle occurs, a fresh surface of the active material particle is exposed and the side reaction with the electrolytic solution occurs at the surface concerned. Consequently, the battery capacity is reduced by repeating large current discharge and the cycle characteristics are degraded.

### Solution to Problem

A non-aqueous electrolyte secondary battery active material, according to the present invention, includes a base particle produced by agglomeration of primary particles made from lithium transition metal oxide containing tungsten and a rare earth compound attached to the surface of the base particle.

### Advantageous Effects of Invention

According to the present invention, a high-capacity non-aqueous electrolyte secondary battery capable of maintaining good cycle characteristics even in the case where large current discharge is repeated can be provided.

### BRIEF DESCRIPTION OF DRAWINGS

FIG. 1 is a sectional view showing a non-aqueous electrolyte secondary battery which is an example of an embodiment according to the present invention.

FIG. 2 is a sectional view showing a positive electrode active material which is an example of an embodiment according to the present invention.

### DESCRIPTION OF EMBODIMENTS

An example of the embodiment according to the present invention will be described below in detail with reference to the drawings. The drawings referred to in the embodiment are schematically described and, therefore, the dimensional ratios of constituent elements and the like shown in the drawings may be different from actuals. Specific dimensional ratios and the like should be assessed in consideration of the following explanations.

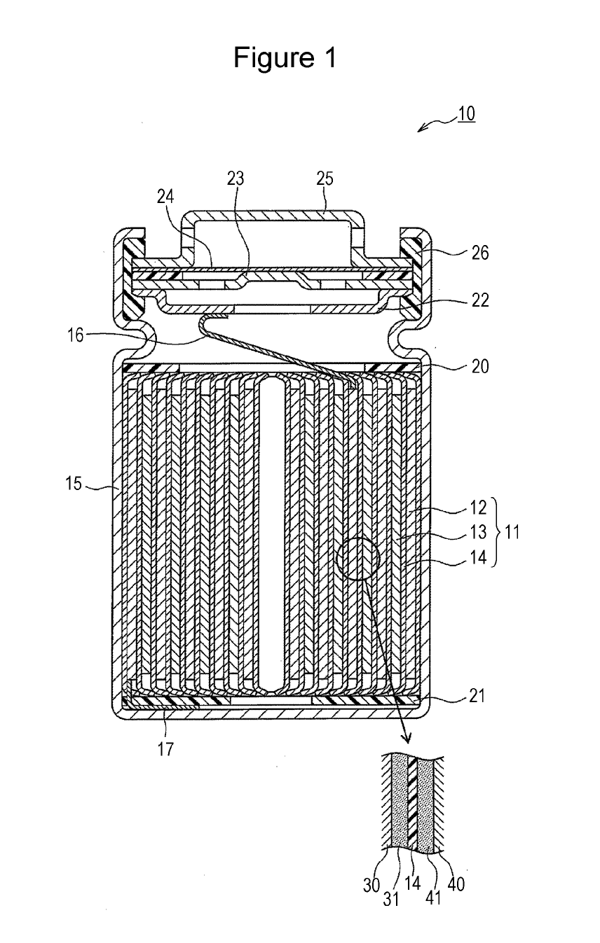

As shown in FIG. 1, a non-aqueous electrolyte secondary battery 10 (hereafter referred to as “secondary battery 10”), which is an example of an embodiment according to the present invention, is a cylindrical battery including an electrode assembly 11 produced by rolling a positive electrode 12 and a negative electrode 13 with a separator 14 therebetween and a non-aqueous electrolyte (not shown in the drawing). Hereafter explanations will be made on the assumption that the structure of the electrode assembly 11 is a rolled structure and an appearance is cylindrical, although the structure and the outward appearance of the electrode assembly are not limited to them. The structure of the electrode assembly may be, for example, a stacked type in which positive electrodes and negative electrodes are stacked alternately with separators therebetween. Also, the outward appearance of the battery may be a rectangular type or a coin type.

The secondary battery 10 includes the electrode assembly 11 and a battery case 15, which stores an electrolyte, provided with a positive electrode lead 16 and a negative electrode lead 17, respectively. The battery case 15 is, for example, a cylindrical metal container with a bottom. In the present embodiment, the negative electrode lead 17 is connected to the inside bottom portion of the battery case 15, and the battery case 15 also serves as a negative electrode external terminal. In this regard, the battery case 15 is not limited to the hard metal container and may be formed from a laminate package.

In the secondary battery 10, insulating plates 20 and 21 are disposed on and under the electrode assembly 11. A filter 22, an inner cap 23, a valve body 24, and a positive electrode external terminal 25 are disposed sequentially above the insulating plate 20. These members are arranged in such a way as to integrally block the opening portion of the battery case 15. Then, a gasket 26 is disposed in gaps between the peripheral edges of these members and the battery case 15 and the inside of the battery case 15 is hermetically sealed. The positive electrode lead 16 is extended upward through the hole of the insulating plate 20 and is connected to the filter 22 by welding or the like. The negative electrode lead 17 is extended downward through the hole of the insulating plate 20 and is connected to the battery case 15 by welding or the like.

[Positive Electrode 12]

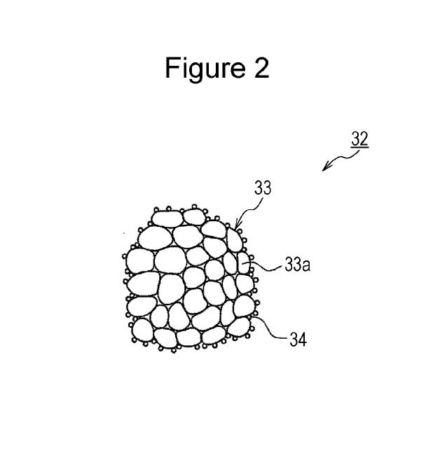

The positive electrode 12 includes a positive electrode collector 30 and a positive electrode active material layer 31 disposed on the collector concerned. Preferably, the positive electrode active material layer 31 is disposed on both surfaces of the positive electrode collector 30. As for the positive electrode collector 30, a thin film sheet having electrical conductivity, in particular metal foil, alloy foil, a film having a metal surface layer, and the like, which are stable in the potential range of the positive electrode 12, can be used. It is preferable that the metal constituting the positive electrode collector 30 be a metal containing aluminum as a primary component, for example, aluminum or an aluminum alloy. Preferably, the positive electrode active material layer 31 contains an electrically conductive material and a binder in addition to a positive electrode active material particle 32 (refer to FIG. 2).

As shown in FIG. 2, the positive electrode active material particle 32 includes a base particle 33 produced by agglomeration of primary particles 33a and rare earth compound particles 34 attached to the surface of the base particle 33. That is, the base particle 33 is a secondary particle formed by contact of primary particles 33a with each other and agglomeration. The primary particle 33a is made from lithium transition metal oxide containing W. The rare earth compound particles 34 are attached to, for example, the surface of the base particle 33 while being dispersed uniformly. Then, the rare earth compound particles 34 are also present in the vicinity of the interface at which the primary particles are in contact with each other (hereafter referred to as “contact interface”. Also, part of the rare earth compound particles 34 may be present while getting into the contact interface.

That is, the positive electrode active material particle 32 includes the rare earth compound particles 34 attached to at least the contact interface or the vicinity thereof (hereafter the term “at least A or B” is referred to as “A and/or B”). Meanwhile, the positive electrode active material particle 32 is made from the lithium transition metal oxide containing at least W. Therefore, W is present at the contact interface or in the vicinity thereof. W is usually present in the primary particle 33a uniformly but may be present on the surface and/or in the surface layer (in the vicinity of the surface in the inside of the primary particle 33a) at a high proportion or be present on the surface and/or in the surface layer of the base particle 33, which is a secondary particle, at a high proportion. Consequently, a stable structure is formed at the contact interface and cracking of the base particle 33 in large current discharge can be suppressed. As a result, good cycle characteristics can be maintained even when charge and discharge are repeated under the condition accompanied by large current discharge.

Preferably, the above-described lithium transition metal oxide be represented by a composition formula LiₓM_{1-y}W_{y}O₂ (M represents at least one type of element selected from the group consisting of Ni, Co, Mn, and Al, where 0.9<x<1.2 and 0.001≦y≦0.01). As for M, at least one metal element of Mg, Ga, Ge, Ti, Sr, Y, Zr, Nb, Mo, Ta, and the like may be contained in addition to the above-described metal elements, e.g., Ni.

In this regard, it is more preferable that the above-described lithium transition metal oxide be represented by a composition formula LiₓNiₐCo_{b}Mn_{c}Al_{(1-y-a-b)}W_{y}O₂ (0.9<x<1.2 0.001≦y≦0.01, 0.30≦a≦0.95, 0≦b≦0.50, and a−c>0.03).

The value of x is preferably 0.9<x<1.2, and more preferably 0.98<x<1.05. If the value of x is 0.9 or less, the stability of the crystal structure is degraded and, for example, an effect of improving the cycle characteristics is reduced. On the other hand, if the value of x is 1.2 or more, there is a tendency of the amount of generation of gas to increase.

The value of y is preferably 0.001≦y≦0.01, and more preferably 0.003≦y≦0.007. If the value of y is less than 0.001, an effect of improving the cycle characteristics due to W is reduced. On the other hand, if the value of y is more than 0.01, there is a tendency of the discharge capacity to decrease.

The reasons a−c>0.03 is preferable are as described below.

(1) In the case where the composition ratio of Mn is high, an impurity phase is generated to cause reduction in the capacity and reduction in the output. Therefore, it is desirable that a−c is 0 or more.
(2) The capacity per positive electrode active material weight increases as the Ni composition ratio is higher. Therefore, it is desirable that the Ni composition ratio is increased as much as possible.

The particle diameter of the primary particle 33a (hereafter referred to as “primary particle diameter”) is preferably 0.2 μm or more and 2 μm or less, and more preferably 0.5 μm or more and 1 μm or less. In this regard, in the present specification, the term “particle diameter” refers to an average particle diameter (D50) observed with a scanning electron microscope (SEM) and an average value of about 10 to 30 particles. If the primary particle diameter is less than 0.2 μm, the number of contact interfaces increases and, therefore, the proportion of the rare earth compound particles 34 attached to the contact interface and/or the vicinity thereof may be reduced. Consequently, for example, stabilization of the structure at the contact interface becomes insufficient, and effects of improving the cycle characteristics and suppressing degradation in the output characteristics may become small. On the other hand, if the primary particle diameter is more than 2 μm, the diffusion distance of lithium ion in the lithium transition metal oxide increases in large current discharge and the output characteristics may be degraded.

The particle diameter of the base particle 33 (secondary particle) (hereafter referred to as “secondary particle diameter”) is preferably 3 μm or more and 20 μm or less, and more preferably 8 μm or more and 15 μm or less. If the secondary particle diameter is less than 3 μm, for example, the positive electrode active material particles 32 are not packed easily during rolling and the polar plate density is not increased, so that an increase in the capacity is difficult. On the other hand, if the secondary particle diameter is more than 20 μm, the diffusion distance of lithium ion in the lithium transition metal oxide increases in large current discharge and the output characteristics may be degraded.

The rare earth compound constituting the rare earth compound particles 34 is preferably a rare earth hydroxide, a rare earth oxyhydroxide, or a rare earth oxide, and more preferably a rare earth hydroxide or a rare earth oxyhydroxide. The effect of improving the cycle characteristics becomes more considerable by using them. In this regard, the rare earth compounds may partly include a rare earth carbonate compound, a rare earth phosphate compound, a fluoride, and the like in addition to them.

Examples of rare earth elements constituting the above-described rare earth compound include scandium, yttrium, lanthanum, cerium, praseodymium, neodymium, samarium, europium, gadolinium, terbium, dysprosium, holmium, erbium, thulium, ytterbium, and lutetium. Among them, neodymium, samarium, and erbium are preferable. This is because neodymium compounds, samarium compounds, and erbium compounds have small average particle diameters as compared with other rare earth compounds and are more uniformly easily precipitated on the surface of the positive electrode active material.

Specific examples of the above-described rare earth compounds include lanthanum hydroxide, lanthanum oxyhydroxide, neodymium hydroxide, neodymium oxyhydroxide, samarium hydroxide, samarium oxyhydroxide, erbium hydroxide, and erbium oxyhydroxide. In this regard, lanthanum is inexpensive and, therefore, in the case where lanthanum hydroxide or lanthanum oxyhydroxide is used, the production cost of the positive electrode 12 can be reduced.

The particle diameter of the rare earth compound particle 34 is preferably 1 nm or more and 100 nm or less, and more preferably 10 nm or more and 50 nm or less. If the particle diameter of the rare earth compound particle 34 is too large, the number per unit weight decreases and the existence probability of the rare earth compound particles 34 at the contact interface and/or in the vicinity thereof decreases. On the other hand, if the particle diameter of the rare earth compound particle 34 is too small, the surface of the base particle 33 is excessively covered with the rare earth compound particles 34, lithium ion occlusion and release performance is degraded, and the charge and discharge characteristics may be degraded.

In the cross-sectional SEM image of the base particle 33 (secondary particle), the proportion of void formed in the inside of the base particle 33 is preferably 0.1% or more and 10% or less relative to the total area of the base particle 33, further preferably 0.5% or more and 8% or less, and particularly preferably 1% or more and 5% or less. The total area of the base particle 33 refers to the area surrounded by the outer perimeter of the base particle 33.

The above-described proportion of void formed in the inside of the base particle 33 relative to the total area of the base particle 33 is calculated, for example, as described below. The average particle diameter of the base particle 33 is determined. Thereafter, in a cross-sectional SEM image of the positive electrode, about 3 to 10 particles having the same size as the average particle diameter are extracted at random. As for each of the extracted base particles 33, the proportion of the area in which a primary particle is not present (void formed in the inside of the base particle 33) relative to the total area is calculated. The average value of about 3 to 10 particles is specified to be the proportion of the void formed in the inside of the base particle 33 relative to the total area of the base particle 33.

If the proportion of the above-described void is less than 0.1%, the amount of electrolytic solution taken into the inside of the base particle 33 (secondary battery) through the primary particle interface becomes insufficient, and the discharge capacity in high rate discharge may become insufficient. On the other hand, if the proportion of the above-described void is more than 10%, the void in the inside of the base particle 33 increases excessively, suppression of a side reaction in the inside may become insufficient because the rare earth compound is not attached. In the case where the proportion of the above-described void is 1% or more and 5% or less, the electrolytic solution penetrates into the inside of the base particle 33, although excess space is not present in the inside of the active material and a state in which contact portion between a primary particle and a primary particle is ensured sufficiently is brought about. Consequently, not only excellent high rate discharge performance and cycle characteristics are obtained but also a polar plate having a high packing density and a high capacity can be obtained.

The rare earth compound particles 34 can be precipitated on the surface of the base particle 33 by, for example, attaching a rare earth salt on the surface of the base particle 33 and, thereafter, performing a heat treatment. In the case where erbium oxyhydroxide is used as the rare earth compound particle 34, for example, an aqueous solution, in which the erbium salt is dissolved, is mixed into a dispersion, in which base particles 33 are dispersed, and thereby, the base particle 33 provided with hydroxide of the erbium salt attached on the surface is obtained. Then, the base particle 33 concerned is heat-treated. The heat treatment temperature is preferably 120° C. or higher and 700° C. or lower, and more preferably 250° C. or higher and 500° C. or lower. In the case of lower than 120° C., moisture adsorbed to the active material is not removed easily and moisture may enters into the battery. On the other hand, in the case of higher than 700° C., for example, the rare earth compound diffuses into the inside of the active material and the effect of improving the cycle characteristics is reduced. In particular, in the case where the heat treatment is performed at 250° C. to 500° C., moisture is removed easily, and a state in which the rare earth compound particles 34 are selectively attached to the surface of the base particle 33 can be formed. In this regard, hydroxide of the rare earth salt may be attached to the surface of the base particle 33 by spraying an aqueous solution in which the rare earth salt is dissolved while the base particle 33 is mixed. As for the rare earth compound particles 34 precipitated on the surface of the base particle 33 by the method through the use of the rare earth salt, the rare earth compound physically adheres to the base particle 33. Consequently, the base particle 33 and the rare earth compound particles 34 attached to the base particle 33 are integrated, and the rare earth compound particles 34 are not isolated from the base particle 33 during slurry production and the like.

The aqueous solution, in which the rare earth salt is dissolved, refers to a solution in which a nitrate compound, a sulfate compound, an acetate compound, or the like of rare earth is dissolved into water. The solution, in which rare earth oxide or the like is dissolved in the acid, e.g., nitric acid, sulfuric acid, or acetic acid, can be assumed to be in the same state as the aqueous solution, in which the rare earth is dissolved, and therefore, can be used as the aqueous solution, in which the rare earth salt is dissolved. In this regard, combinations of them can also be used.

Also, it is possible to mix the base particle 33 and the rare earth compound particles 34 by using a mixing treatment machine to mechanically attach the rare earth compound particles 34 to the surface of the base particle 33. In this case as well, it is preferable that the heat treatment be performed under the same condition as the above-described method by using the rare earth salt.

As for the method for attaching the rare earth compound particles 34, among the above-described methods, the method by using the rare earth salt is preferable, and the method by mixing the aqueous solution, in which the rare earth salt, e.g., an erbium salt, is dissolved, into the dispersion of the base particle 33 is particularly preferable. According to that method, the rare earth compound particles 34 can be attached to the surface of the base particle 33, while being dispersed more uniformly. As for the rare earth compound particles 34 attached to the base particle 34 by that method, the rare earth compound is attached to the surface of the base particle 33 without being isolated, so that cracking of the base particle 33 in large current discharge can be suppressed and in the case where charge and discharge are performed repeatedly under the condition accompanied by large current discharge, the cycle characteristics are still more improved. In that method, preferably the pH of the dispersion of the base particle 33 is specified to be constant, and particularly preferably the pH is specified to be 6 to 10. Consequently, the rare earth compound particles 34 which are fine particles of 1 to 100 nm are easily uniformly precipitated on the entire surface of the base particle 33. In this regard, if the pH is less than 6, a transition metal constituting the base particle 33 may be eluted. On the other hand, if the pH is more than 10, the rare earth compound particles 34 may be segregated.

The amount of attachment of the rare earth compound particles 34 is preferably 0.003 percent by mole or more and 0.25 percent by mole or less on a proportion of rare earth element relative to the total mole number of transition metal constituting the base particle 33 basis. If the proportion is less than 0.003 percent by mole, an effect of attaching the rare earth compound particles 34 is not exerted sufficiently in some cases. On the other hand, if the proportion is more than 0.25 percent by mole, the reactivity of the lithium transition metal oxide on the particle surface may be reduced and the cycle characteristics in large current discharge may be degraded.

The above-described electrically conductive agent is used for enhancing the electrical conductivity of the positive electrode active material layer. Examples of electrically conductive agents include carbon materials, e.g., carbon black, acetylene black, Ketjenblack, and graphite. These may be used alone or at least two types may be used in combination. The above-described binder is used for maintaining good contact state between the positive electrode active material and the electrically conductive agent and enhancing the bondability of the positive electrode active material and the like to the positive electrode collector surface. As for the binder, for example, polytetrafluoroethylene (PTFE), polyvinylidene fluoride (PVdF), and modified products thereof are used. The binder may be used together with a thickener, e.g., carboxymethyl cellulose (CMC) or polyethylene oxide (PEO).

[Negative Electrode 13]

The negative electrode 13 includes a negative electrode collector 40 and a negative electrode active material layer 41 disposed on the collector. Preferably, the negative electrode active material layer 41 is disposed on both surfaces of the negative electrode collector 40. As for the negative electrode collector 40, a thin film sheet having electrical conductivity, in particular metal foil, alloy foil, a film having a metal surface layer, and the like, which are stable in the potential range of the negative electrode 13, can be used. It is preferable that the metal constituting the negative electrode collector 40 be a metal containing copper as a primary component.

Preferably, the negative electrode active material layer 41 includes, for example, a binder in addition to the negative electrode active material to reversively occlude and release lithium ions. As for the negative electrode active material, carbon materials, metals which are alloyed with lithium, alloy materials, metal oxides, and the like can be used. It is preferable that carbon materials be used for the negative electrode active material from the viewpoint of material cost reduction. Examples of carbon materials can include natural graphite, artificial graphite, mesophase pitch based carbon fibers (MCF), mesocarbon microbeads (MCMB), coke, and hard carbon. In particular, from the viewpoint of improvement of the charge and discharge characteristics, it is preferable that the carbon material in which a graphite material is covered with low crystalline carbon be used. As for the binder, PTFE and the like can be used in the same manner as with the positive electrode, although it is preferable that a styrene-butadiene copolymer (SBR), modified products thereof, or the like be used. The binder may be used together with a thickener, e.g., CMC.

[Separator 14]

A porous sheet having ion permeability and an insulating property is used for the separator 14. Specific examples of porous sheets include fine porous thin films, woven fabrics, and nonwoven fabrics. As for the material for the separator 40, cellulose and olefin resins, e.g., polyethylenes and polypropylenes, are preferable. Also, a polyethylene having a surface provided with a polypropylene layer or a polyethylene separator having a surface coated with an aramid resin may be used.

A layer including a layer of inorganic material filler (filler layer) can be disposed at the interface between the positive electrode 12 and the separator 14 or the interface between the negative electrode 13 and the separator 14. As for the filler, for example, oxides or phosphate compounds of titanium, aluminum, silicon, magnesium, and the like and those having surfaces treated with a hydroxide or the like can be used. The filler layer can be formed by, for example, a method in which formation is performed by directly applying a filler-containing slurry to the positive electrode 12, the negative electrode 13, or the separator 14 and a method in which a sheet including a filler is stuck on the positive electrode 12, the negative electrode 13, or the separator 14.

[Non-Aqueous Electrolyte]

The non-aqueous electrolyte contains a non-aqueous solvent and a solute (electrolyte salt) dissolved in the non-aqueous solvent. The non-aqueous electrolyte is not limited to a liquid electrolyte (non-aqueous electrolytic solution) and may be a solid electrolyte by using a gel polymer or the like.

The above-described non-aqueous solvent is not specifically limited and previously known solvents can be used. Examples of non-aqueous solvents can include cyclic carbonates, e.g., ethylene carbonate, propylene carbonate, butylene carbonate, and vinylene carbonate, chain carbonates, e.g., dimethyl carbonate, methylethyl carbonate, and diethyl carbonate, ester-containing compounds, e.g., methyl acetate, ethyl acetate, propyl acetate, methyl propionate, ethyl propionate, and γ-butyrolactone, sulfone-containing compounds, e.g., propane sultone, ether-containing compounds, e.g., 1,2-dimethoxyethane, 1,2-diethoxyethane, tetrahydrofuran, 1,2-dioxane, 1,4-dioxane, and 2-methyl tetrahydrofuran, nitrile-containing compounds, e.g., butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile, and amide-containing compounds, e.g., dimethylformamide. Also, halogen substitution products in which part of hydrogen in these solvent has been substituted with halogen atoms, e.g., fluorine, may be used. For example, fluorinated cyclic carbonic acid esters and fluorinated chain carbonic acid esters can be used alone or in combinations of a plurality of types. A compound containing a small amount of nitrile or an ether-containing compound may be mixed into them.

Also, an ionic liquid can be used as the above-described non-aqueous solvent. The cation species and anion species of the ionic liquid are not specifically limited. However, from the viewpoint of low viscosity, electrochemical stability, and hydrophobicity, a combination by using a pyridinium cation, an imidazolium cation, or quaternary ammonium cation as the cation and a fluorine-containing imide anion as the anion is particularly preferable.

The above-described solute is preferably a lithium salt. As for the lithium salt, a lithium salt containing at least one element of P, B, F, O, S, N, and Cl can be used. Specifically, lithium salts, e.g., LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, and LiPF₂O₂, and mixtures thereof can be used. In particular, in order to enhance the high rate charge and discharge characteristics and the durability of the non-aqueous electrolyte secondary battery, it is preferable to use LiPF₆.

Also, a lithium salt, in which an oxalate complex serves as an anion, can be used as the above-described solute. As for the lithium salt in which an oxalate complex serves as an anion, besides LiBOB [lithium-bisoxalate borate], a lithium salt having an anion in which C₂O₄²⁻ is coordinated to the center atom, for example, a lithium salt represented by Li[M(C₂O₄)ₓR_{y}] (in the formula, M represents an element selected from transition metals and group 13, group 14, and group 15 of the periodic table, R represents a group selected from halogens, alkyl groups, and halogen-substituted alkyl groups, x represents a positive integer, and y represents 0 or a positive integer) can be used. Specific examples include Li[B(C₂O₄)F₂], Li[P(C₂O₄)F₄], and Li[P(C₂O₄)₂F₂]. In order to form a stable coating film on the negative electrode surface even under a high temperature environment, LiBOB is preferable.

The above-described solutes may be used alone or at least two types may be used in combination. The concentration of the solute is not specifically limited, although 0.8 to 1.7 mol per liter of electrolytic solution is desirable. In this regard, in the use where large current discharge is required, the concentration of the solute is desirably 1.0 to 1.6 mol per liter of electrolytic solution.

The present invention will be described below in further detail with reference to experimental examples, although the present invention is not limited to these experimental examples.

### Example 1

### Experimental Example 1

### Synthesis of Positive Electrode Active Material

A raw material solution was obtained by dissolving 1,600 g of mixture of nickel sulfate, cobalt sulfate, and manganese sulfate mixed in such a way that the atomic ratio Ni to Co to Mn became 55:20:25 into 5 liter of water. A precipitate was generated by adding 200 g of sodium hydroxide to the resulting raw material solution. The resulting precipitate was washed with water sufficiently and was dried to obtain a coprecipitated transition metal hydroxide.

The resulting coprecipitated transition metal hydroxide was fired at 750° C. for 12 hours to obtain a transition metal oxide. After 515 g of Li₂O₃ and 15.8 g of WO₃ were mixed into 1,000 g of the resulting transition metal oxide, firing was performed at 1,000° C. for 12 hours to obtain a lithium transition metal oxide particle A1. As a result of the XRD measurement, it was found that the crystal structure of the lithium transition metal oxide particle A1 was a single phase assigned to the space group R3-m. Also, it was ascertained on the basis of the ICP emission spectrochemical analysis that the composition of the lithium transition metal oxide particle A1 was LiNi_{0.545}Co_{0.20}Mn_{0.25}W_{0.005}O₂. It was ascertained on the basis of scanning electron microscope (SEM) observation that the lithium transition metal oxide particle A1 was a secondary particle produced by agglomeration of primary particles (average particle diameter (D50) on the basis of SEM observation was 0.4 μm). Meanwhile, the average particle diameter (D50) of the secondary particles was 14 μm. In this regard, the average particle diameter (D50) of the secondary particles was determined by using a laser diffraction particle size distribution analyzer, integrating the volumes of particles from the small particle diameter side sequentially, and calculating the particle diameter when the integrated volume reached 50% of the total volume of particles.

Also, in the SEM observation, 3 particles having the same size as the average particle diameter 14 μm of the secondary particles were extracted at random. The extracted 3 secondary particles were subjected to image processing, the area of region, in which no primary particle was present, was determined, and the proportion of the void relative to the total area of the secondary particle was calculated. The average value of the 3 particles was 3%.

Subsequently, 1,000 g of lithium transition metal oxide particle A1 was put into 3 liter of pure water and agitation was performed. Thereafter, a solution in which 4.58 g of erbium nitrate pentahydrate was dissolved was added thereto. In this case, 10-percent by mass sodium hydroxide aqueous solution was added appropriately to adjust the pH of the solution containing the lithium transition metal oxide particle A1 to 9 (in such a way that the pH is maintained at 9). Then, suction filtration and water washing were performed and, thereafter, the resulting powder was dried by firing at 400° C. for 5 hours. In this manner, a positive electrode active material B1, in which erbium oxyhydroxide was attached to the surface of the lithium transition metal oxide particle A1, was obtained. The amount of attachment of the erbium oxyhydroxide was 0.1 percent by mole on an erbium element basis relative to the total amount of moles of transition metal of the lithium transition metal oxide particle A1. Meanwhile, it was ascertained on the basis of the SEM observation of the positive electrode active material B1 that erbium oxyhydroxide was attached to the vicinity of the interface at which the primary particles of the lithium transition metal oxide particle A1 were in contact with each other.

Also, it was ascertained on the basis of SEM-EPMA observation of the cross-section that W was present in the inside of the primary particle and at the interface between a primary particle and a primary particle and was in the state in which 75% or more thereof was present in the inside of the primary particle (solid solution).

[Production of Positive Electrode]

A positive electrode slurry was prepared by mixing 4 parts by mass of carbon black serving as a carbon electrically conductive agent and 2 parts by mass of polyvinylidene fluoride serving as a binder into 94 parts by mass of positive electrode active material B1 and further adding an appropriate amount of NMP (N-methyl-2-pyrrolidone). Then, the resulting positive electrode slurry was applied to both surfaces of the positive electrode collector made from aluminum. Subsequently, the coating material was dried and rolled by using a roller, so that a positive electrode active material layer was formed on the collector. Finally, the collector provided with the active material layer was cut into a predetermined electrode size and a positive electrode lead was attached, so that a positive electrode was obtained.

[Production of Negative Electrode]

A negative electrode slurry was prepared by mixing 97.5 parts by mass of artificial graphite serving as an negative electrode active material, 1 part by mass of CMC serving as a thickener, and 1.5 parts by mass of SBR serving as a binder and adding an appropriate amount of pure water. Then, the resulting negative electrode slurry was applied to both surfaces of the negative electrode collector made from copper foil. Subsequently, the coating material was dried and rolled by using a roller, so that a negative electrode active material layer was formed on the collector. Finally, the collector provided with the active material layer was cut into a predetermined electrode size and a negative electrode lead was attached, so that a negative electrode was obtained.

[Preparation of Non-Aqueous Electrolytic Solution]

A mixed solvent was used, where EC (ethylene carbonate), MEC (methyl ethyl carbonate), DMC (dimethyl carbonate), PC (propylene carbonate), and FEC (fluoroethylene carbonate) were mixed at a volume ratio of 10:10:65:5:10. A solute LiPF₆ was dissolved into the mixed solvent at a ratio of 1.5 mol/liter. A non-aqueous electrolytic solution was prepared by further adding VC (vinylene carbonate) and lithium difluorophosphate in such a way that the proportions became 1 percent by weight and 0.5 percent by weight, respectively, relative to the total weight of the non-aqueous electrolytic solution.

[Production of Non-Aqueous Electrolyte Secondary Battery]

The above-described positive electrode and the above-described negative electrode were arranged oppositely with a separator formed from polyethylene fine porous film therebetween and, thereafter, were rolled into a spiral shape by using a core. Then, the core was pulled out to produce a spiral electrode assembly. The resulting electrode assembly was inserted into a metal outer can (battery case). Subsequently, the above-described non-aqueous electrolytic solution was injected and sealing was performed, so that Test cell C1 which was a cylindrical (18650 type) non-aqueous electrolyte secondary battery (theoretical amount: 2.0 Ah) having a diameter of 18 mm and a height of 65 mm was produced.

### Experimental Example 2

Test cell Z1 was produced in the same manner as Experimental example 1 except that erbium oxyhydroxide was not used.

### Experimental Example 3

Test cell Z2 was produced in the same manner as Experimental example 1 except that WO₃ was not used and lithium transition metal oxide was fired at 950° C.

### Experimental Example 4

Test cell Z2 was produced in the same manner as Experimental example 1 except that neither WO₃ nor erbium oxyhydroxide was used and lithium transition metal oxide was fired at 950° C.

[Evaluation of Cycle Characteristics]

Charge and discharge of each of Test cells C1 and Z1 to Z3 were repeated under the following condition, and the number of cycles at which the capacity retention became 75% (hereafter referred to as “the number of cycles_{(75%)}”) was examined. The results thereof and the like are shown in Table 1.

(Charge and Discharge Condition)

Constant current charge to a battery voltage of 4.2 V was performed at a charge current of 2.0 It (4.0 A) under a temperature condition of 25° C. and, furthermore, constant voltage charge was performed at a constant voltage of battery voltage 4.2 V until the current reached 0.02 lt (0.04 A). Subsequently, constant current discharge to 2.5 V was performed at a discharge current of 10.0 lt (20.0 A).

TABLE 1

| | | Erbium oxyhydroxide | |
|---|---|---|---|
| Test | Tungsten | (amount of | Number of |
| cell | (amount of addition) | attachment) | cycles_{(75%)} |
| C1 | added | attached | 672 |
| | (0.5 percent by mole) | (0.1 percent by mole) | |
| Z1 | added | none | 300 |
| | (0.5 percent by mole) | | |
| Z2 | none | attached | 450 |
| | | (0.1 percent by mole) | |
| Z3 | none | none | 300 |

As is clear from Table 1, it can be ascertained that the number of cycles_{(75%)} of Test cell C1 was large as compared with those of Test cells Z1 to Z3. In this regard, in the case where the positive electrode active material particle containing no rare earth compound (erbium oxyhydroxide) was used (Test cells Z1 and Z3), good cycle characteristics were not obtained regardless of presence of tungsten. Meanwhile, in the case where the positive electrode active material containing no tungsten was used (Test cells Z2 and Z3), the number of cycles_{(75%)} was increased by attaching the rare earth compound to the surface of the lithium transition metal oxide particle, although the degree was still insufficient.

That is, the number of cycles_{(75%)} cannot be increased by merely allowing the lithium transition metal oxide to contain tungsten. In this regard, the same goes for the case where merely the rare earth compound is attached to the lithium transition metal oxide particle. On the other hand, the number of cycles_{(75%)} is particularly increased and the cycle characteristics are improved considerably by using the lithium transition metal oxide containing tungsten and attaching the rare earth compound to the surface of the particles thereof, specifically allowing the rare earth compound to become present at the interface and/or in the vicinity of the interface at which the primary particles constituting the lithium transition metal oxide particle are in contact with each other.

The reason for this is considered to be as described below. In the lithium transition metal oxide allowed to contain tungsten, a side reaction occurs under the influence of heat generation of a battery during large current discharge, and cracking of particle is facilitated. In the case where a rare earth element, which is exemplified by erbium, inert to lithium is present at the interface and/or in the vicinity of the interface at which the primary particles constituting the lithium transition metal oxide particle are in contact with each other, the above-described side reaction is suppressed. That is, a stable structure is formed at the contact interface between primary particles of the positive electrode active material without impairing high lithium diffusibility exhibited by the lithium transition metal oxide containing tungsten by using tungsten and the rare earth compound in combination, and cracking of active material particles can be suppressed during large current discharge.

### Example 2

### Experimental Example 5

Test cell C2 was produced in the same manner as Experimental example 1 except that lanthanum•hexahydrate was used in place of erbium nitrate•pentahydrate. The resulting powder was observed with the SEM. As a result, lanthanum oxyhydroxide was present in the vicinity of the interface at which primary particles constituting the lithium transition metal oxide particle were in contact with each other, W was present in the inside of the primary particle, and part of W was present at the interface between a primary particle and a primary particle as with Experimental example 1.

### Experimental Example 6

Test cell C3 was produced in the same manner as Experimental example 1 except that neodymium•hexahydrate was used in place of erbium nitrate•pentahydrate. The resulting powder was observed with the SEM. As a result, neodymium oxyhydroxide was present in the vicinity of the interface at which primary particles constituting the lithium transition metal oxide particle were in contact with each other, W was present in the inside of the primary particle, and part of W was present at the interface between a primary particle and a primary particle as with Experimental example 1.

### Experimental Example 7

Test cell C4 was produced in the same manner as Experimental example 1 except that samarium•hexahydrate was used in place of erbium nitrate•pentahydrate. The resulting powder was observed with the SEM. As a result, samarium oxyhydroxide was present in the vicinity of the interface at which primary particles constituting the lithium transition metal oxide particle were in contact with each other, W was present in the inside of the primary particle, and part of W was present at the interface between a primary particle and a primary particle as with Experimental example 1.

[Evaluation of Cycle Characteristics]

The cycle characteristics of Test cells C2 to C4 were evaluated under the same condition as the condition of Example 1 above. The results thereof are shown in Table 2.

TABLE 2

| | Tungsten | | Amount of addition | |
|---|---|---|---|---|
| Test | (amount of | Rare earth | of rare earth | Number of |
| cell | addition) | element | element | cycles_{(75%)} |
| C1 | added | erbium | 0.1 percent by mole | 672 |
| | (0.5 percent | | | |
| | by mole) | | | |
| C2 | added | lanthanum | 0.1 percent by mole | 640 |
| | (0.5 percent | | | |
| | by mole) | | | |
| C3 | added | neodymium | 0.1 percent by mole | 644 |
| | (0.5 percent | | | |
| | by mole) | | | |
| C4 | added | samarium | 0.1 percent by mole | 652 |
| | (0.5 percent | | | |
| | by mole) | | | |

As is estimated from Table 2, in the case where a rare earth compound, e.g., a lanthanum compound, a neodymium compound, or samarium compound, is attached to the lithium transition metal oxide particle as well, the same effect as the effect in the case where the erbium compound is used is obtained.

### Example 3

### Experimental Example 8

Test cell D1 was produced in the same manner as Experimental example 1 except that after 515 g of Li₂CO₃, 15.8 g of WO₃, and 5.15 g of ZrO₂ were mixed into 1,000 g of the resulting transition metal oxide, firing was performed at 1,000° C. for 12 hours, and a positive electrode active material particle B2, in which erbium oxyhydroxide is uniformly attached to the surface, was obtained by using the resulting lithium transition metal oxide particle A2. In this regard, it was ascertained on the basis of the ICP emission spectrochemical analysis that the composition of the lithium transition metal oxide particle A2 was LiNi_{0.545}Co_{0.20}Mn_{0.25}W_{0.005}Zr_{0.003}O₂. The average value of proportions of the void relative to the total area of the secondary particle of the lithium transition metal oxide particle A2, calculated as in Experimental example 1, was 3%. It was ascertained on the basis of the SEM observation of the positive electrode active material B2 that erbium oxyhydroxide was attached to the vicinity of the interface at which the primary particles of the lithium transition metal oxide particle A2 were in contact with each other. Also, it was ascertained that Zr and W were present in the inside of the primary particle of the lithium transition metal oxide particle A2, and W was present at the interface between a primary particle and a primary particle.

[Evaluation of Cycle Characteristics]

The cycle characteristics of Test cells D1 were evaluated under the same condition as the condition of Example 1 above. The results thereof are shown in Table 3.

TABLE 3

| | | | | Amount of | |
|---|---|---|---|---|---|
| | Tungsten | Zirconium | Rare | addition of | |
| Test | (amount of | (amount of | earth | rare earth | Number of |
| cell | addition) | addition) | element | element | cycles_{(75%)} |
| C1 | added | none | erbium | 0.1 percent | 672 |
| | (0.5 percent | | | by mole | |
| | by mole) | | | | |
| D1 | added | added | erbium | 0.1 percent | 692 |
| | (0.5 percent | (0.3 percent | | by mole | |
| | by mole) | by mole) | | | |

As is clear from Table 3, the cycle characteristics in large current discharge of Test cell D1 are still further improved as compared with the cycle characteristics of Test cell C1. The reason for this is considered to be that zirconium was further contained in the inside of the primary particle in the state in which tungsten was contained, not only the ion diffusibility in the inside of the crystal was improved but also an interaction with the rare earth compound present on the secondary particle surface was further enhanced, and cracking from the interface was able to be suppressed.

As described above, the non-aqueous electrolyte secondary battery which is an example of the embodiment according to the present invention has a high-capacity and can maintain good cycle characteristics even in the case where large current discharge is repeated. In the case where there is a need to discharge at a large current, such as, 2.0 lt, 5.0 lt, or 10 lt, the non-aqueous electrolyte secondary battery is particularly useful in the uses of, for example, electric cars, HEVs, and electric tools.

### INDUSTRIAL APPLICABILITY

The present invention can be expected to be developed to a driving power supply for information terminals, e.g., cellular phones, notebook personal computers, and smart phones, a driving power supply for high outputs, e.g., electric cars, HEVs, and electric tools, and a power supply related to storage of electricity.

### REFERENCE SIGNS LIST

10 non-aqueous electrolyte secondary battery, 11 electrode assembly, 12 positive electrode, 13 negative electrode, 14 separator, 15 battery case, 16 positive electrode lead, 17 negative electrode lead, 20, 21 insulating plate, 22 filter, 23 inner cap, 24 valve body, positive electrode external terminal, 26 gasket, 30 positive electrode collector, 31 positive electrode active material layer, 32 positive electrode active material particle, 33 base particle, 34 rare earth compound particle, negative electrode collector, 41 negative electrode active material layer

1. A non-aqueous electrolyte secondary battery active material comprising:
a base particle produced by agglomeration of primary particles made from lithium transition metal oxide containing tungsten; and
a rare earth compound attached to the surface of the base particle.

2. The non-aqueous electrolyte secondary battery active material according to claim 1,
wherein the rare earth compound is attached to the interface at which the primary particles are in contact with each other or the vicinity of the interface.

3. The non-aqueous electrolyte secondary battery active material according to claim 1,
wherein the tungsten is contained in the inside of the primary particle.

4. The non-aqueous electrolyte secondary battery active material according to claim 1,
wherein zirconium is contained in the inside of the primary particle.

5. The non-aqueous electrolyte secondary battery active material according to claim 1,
wherein the lithium transition metal oxide is represented by a composition formula LiₓM_{1-y}W_{y}O₂ (M represents at least one type of element selected from the group consisting of Ni, Co, Mn, and Al, where 0.9<x<1.2 and 001≦y≦0.01).

6. The non-aqueous electrolyte secondary battery active material according to claim 1,
wherein the rare earth compound contains at least one type of erbium, lanthanum, neodymium, and samarium.

7. The non-aqueous electrolyte secondary battery active material according to claim 1,
wherein the proportion of void formed in the inside of the base particle is 0.1% or more and 10% or less relative to the total area of the base particle in the cross-sectional SEM image of the base particle.

8. A non-aqueous electrolyte secondary battery comprising:
a positive electrode by using the positive electrode active material according to claim 1;
a negative electrode by using a negative electrode active material capable of occluding and releasing lithium;
a separator disposed between the positive electrode and the negative electrode; and
a non-aqueous electrolyte.
